(19) United States
(12) Patent Application Publication
(10) Pub. No.: US 2016/0267811 A1
(43) Pub. Date: Sep. 15, 2016

(54) SYSTEMS AND METHODS FOR TEACHING FOREIGN LANGUAGES

(71) Applicant: John DONOHUE, Braintree, MA (US)

(72) Inventor: John DONOHUE, Braintree, MA (US)

(21) Appl. No.: 15/065,474

(22) Filed: Mar. 9, 2016

Related U.S. Application Data
(60) Provisional application No. 62/130,283, filed on Mar. 9, 2015.

(51) Int. Cl. G09B 19/06; G09B 5/06

(52) U.S. Cl. CPC G09B 19/06; G09B 5/06

(57) ABSTRACT

A method for retaining new languages through a method of selecting subsets of sentence forms of the new language so that the selected subsets can be immediately reproduced either in isolation or in different sentence forms, and wherein the selected subsets may be subject to further sub-sectioning.

### CROSS-REFERENCE TO RELATED APPLICATION

This application claims the benefit of priority of U.S. provisional application No. 62/130,283, filed 9-Mar.-2015, the contents of which are herein incorporated by reference.

### BACKGROUND OF THE INVENTION

The present invention relates to methods for teaching foreign languages and, more particularly, to a system for students to retain foreign languages through a method of selecting subsets of sentence forms of the foreign language so that the selected subsets can be immediately reproduced either in isolation or in different sentence forms, and wherein the selected subsets may be subject to further sub-sectioning.

Language textbooks usually come with one or more audio CDs. These audio CDs contain phonetics, sentences and words. There are several significant issues with such language CDs: the amount of time it takes for a student to locate a sound greatly impacts efficiency; sentence quality can vary making it difficult for a beginning student to recognize a word, and slowing down the sentence does not solve the problem; and large sentences are also very difficult to deal with because there is no way to break a sentence form into more digestible sentence fragments.

Current language textbooks/CDs do not work because they are produced by publishers. Their expertise is publishing not software. Language books are expensive, and the product margins are huge—why change?

As a result, current language textbooks/CDs prolong gross learning inefficiencies, such as requiring a beginner to spend up to 15 minutes or more to locate a desired portion of a sentence form.

As can be seen, there is a need for a system for students to retain foreign languages through a method of selecting subsets of sentence forms of the foreign language so that the selected subsets can be immediately reproduced either in isolation or in different sentence forms, and wherein the selected subsets may be subject to further sub-sectioning, thereby eliminating the need to search the current language CDs for a specific audio clip to provide a desired fragment the user wishes to retain and learn.

### SUMMARY OF THE INVENTION

In one aspect of the present invention, a computer implemented method for learning a new language includes the following steps: (a) electronically representing a plurality of data sets of the new language; (b) providing a drill down functionality configured to prompt a user to select at least one first data set of the plurality of data sets; (c) providing an audible representation associated with said at least one first data set; (d) prompting the user to repeat said audible representation, select at least one second data set from the plurality of data sets, and select a first subset of said at least one first data set; and (e) sequentially repeating steps (c) through (d) in respect of said at least one second and/or further data sets of the plurality of data sets or said second and/or further subsets of said at least one first data set.

In another aspect of the present invention, the computer implemented method for learning a new language includes the following steps: (a) importing the plurality of data sets from an external storage system; (b) electronically representing a plurality of data sets of the new language, wherein the plurality of data sets comprise at least one of a sentence form, a base subset or a structural subset of the new language; (c) providing a drill down functionality configured to prompt a user to select at least one first data set of the plurality of data sets; (d) providing an audible representation associated with said at least one first data set; (e) prompting the user to repeat said audible representation, select at least one second data set from the plurality of data sets, and select a first subset of said at least one first data set; (f) sequentially repeating steps (d) through (e) in respect of said at least one second and/or further data sets of the plurality of data sets or said second and/or further subsets of said at least one first data set; (g) providing a floating dictionary database configured to retrievably store the selected data sets and subsets from steps (d) and (e); (h) providing a literal English functionality configured to provide a literal translation of the selected data sets and subsets from steps (d) and (e) into an order that mimics the grammatical structure of the new language, wherein each literal translation is electronically represented adjacent to the selected data sets and subsets from steps (d) and (e); and (i) providing a pictorial representation of imagery associated with the selected data sets and subsets from steps (d) and (e).

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention; and

FIG. 3 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for retaining new languages through a method of selecting subsets of sentence forms of the new language so that the selected subsets can be immediately reproduced either in isolation or in different sentence forms, and wherein the selected subsets may be subject to further sub-sectioning.

The present invention was developed specifically for Mandarin Chinese, since there seems to be a general agreement that Mandarin is one of the most difficult languages to learn. This is not, however, intended to be Mandarin specific invention and can be used for learning and retaining any new language.

The present invention embodies the following processes and functionality:

Literal English—

learning a language is significantly more than just learning words. The way in which these words are structured is extremely important. Take, for example this sentence:

“I am going to the library tomorrow.”

Mixing Chinese grammar with English words would get you this sentence:

“I tomorrow go library.”

This is Literal English—translation of English words in Chinese grammatical structural order.

Sentence Drill Down—

As one studies a new language, the sentences get longer and more complex. The sentence drill down technique provides the student with the capability to selectively drill down through sets and subsets of a sentence form. By way of example, there are thirteen words in the following sentence form:

[symbol]

[symbol]

[symbol]

, [symbol] ?

Through the sentence drill down technique, a student may engage a selected subset (the subset may be the entire sentence form), visually and/or audibly, in the follow ways:
(a) The entire sentence form, if that is the selected subset;
(b) Word by word through the selected subset, including the entire sentence form if that is the selected subset or no selection is made;
(c) Select a base subset from the selected subset, such as a base word (may be more than one symbol) and view and/or listen to the subset written/spoken; and
(d) Select a structural subset (containing more than one base word) from the selected subset and view and/or listen to the structural subset written/spoken.
   With this enhancement the student can drilldown as follows:

[symbol]

[symbol]

[symbol]

[symbol]

[symbol]

[symbol]

[symbol]

Floating Dictionary—

As a student learns a language, he does not need a complete dictionary to bog down the learning and retaining process; rather, the student needs a limited, tailored dictionary containing what he has learned and what he is now studying within a predetermined time frame. Such “floating dictionary” should be integrated into the learning process. The student should be able to find a word in a couple of seconds, without moving his hands from the keyboard.

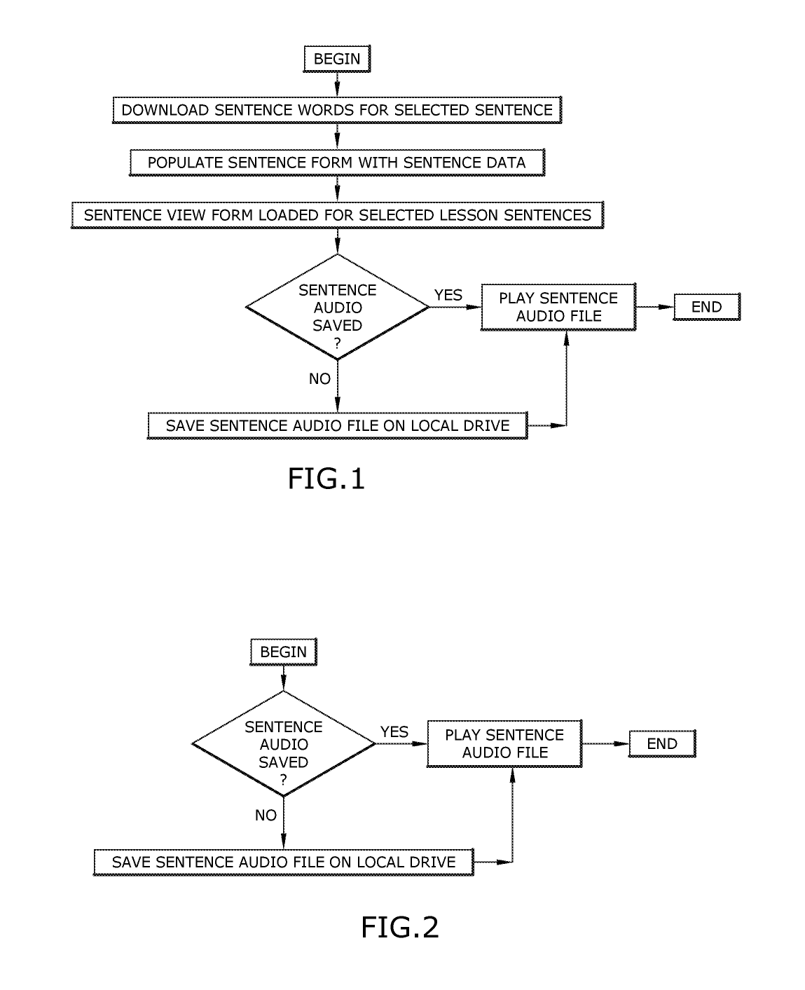

Referring to FIGS. 1 through 3, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may include a floating dictionary database accessibly by the software and/or computer. The floating dictionary database may be adapted to retrievably store a plurality of data sets. Each data set may be an audio representation and/or visual representation of at least one base subset of a language, such as a base word. The data sets may include structural subsets of the language, wherein structural components are two or more base words combined to form a portion or an entire sentence form of the language. For example, “I am going to the library tomorrow” may be the sentence form, “am going” may be a structural subset composed of the combination of two base subset (words) “am” and “going.” The data sets may be defined as either sentence forms, structural and/or base subsets thereof.

The software may be adapted to import (from exterior storage devices) and group the plurality of data sets into a plurality of lessons that are electronically represented (at least visually and audibly) to a user on the user interface, wherein each lesson may sequentially or simultaneously produce each data set, as schematically illustrated in FIG. 1. When the user engages or interfaces with a particular data set (either through a graphic user interface, GUI, or the like), the software enables the above mentioned functionality: the particular data set is retrievably stored in the floating dictionary, as schematically illustrated in FIG. 2; a Literal English translation is electronically produced on the user interface; and the sentence drill down functionality is enabled for the user to select subsets of each data set and subsets of such subsets.

The software enables the user to repeatedly display (visually and audibly) the Literal English translation and the sentence drill down technique disclosed above. Each selected drill down set or subset is retrievably stored in the floating dictionary for future display or playback. The software may be adapted so that the speed of playback of at least the audio output of each data set may be adjustable, so that each user may adapt the playback speed to their level of retention and learning.

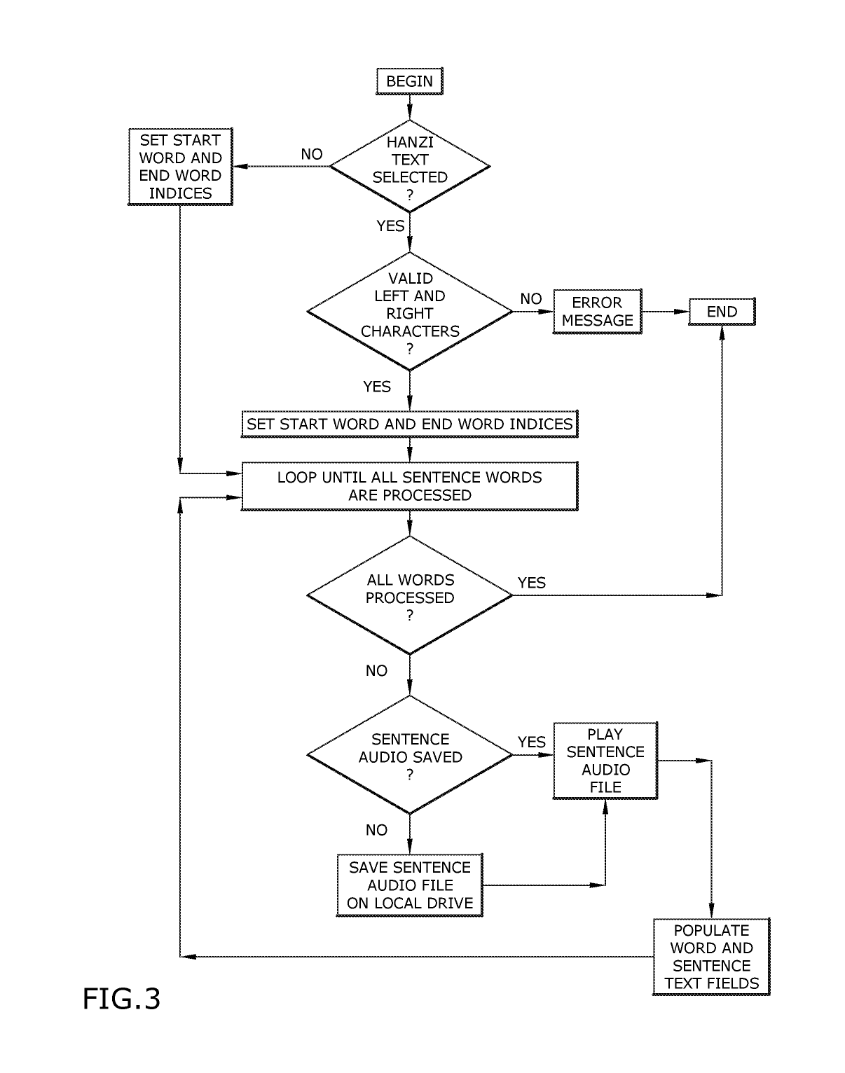

By way of example, a student-user might understand the first half of a data set defining a predetermined sentence form, but may be confused by the second half of the predetermined sentence form, e.g., a structural subset. The student can select this structural subset of the predetermined sentence form and have it electronically represented through the user interface. The student-user may only hear the selected structural subset. The selection is dynamic, whereby the student-user can repeatedly drill down (through the sentence drill down technique) by selecting a further subset, say a base subset thereof, like a base word, of the already selected structural subset. Then the student-user would have the ability to repeatedly display (audibly and visually of the user interface) the latest selected base subset at desired speeds or display, as schematically illustrated in FIG. 3, as well as utilize the floating dictionary and Literal English functionality with this latest selected base subset.

There are several advantages to this. While not apparent to the student-user, the above mentioned functionality has been developed that significantly reduces network traffic and the costs associated with this traffic. Furthermore, the above mentioned functionality increases the productivity of the student-user, by eliminating the need to search current language CDs for a specific audio clip. For a beginner it could 15 minutes or more to locate a specific clip on such a CD. Even if the person is using an internet tool to get the audio, it is nowhere near as fast as the present invention, which is completely transparent and seamless.

A method of using the present invention may include the following. The present invention disclosed above may be provided. When the software begins, a list of lessons may be displayed. A user may select a desired lesson and then select at least one of a plurality of data sets included in the desired lesson. Again, the desire lesson may be imported from an external source/system, and so the plurality of data sets may not be currently stored in the floating dictionary. Each data set may be a sentence form, a base subset or a structural subset. The user may select a desired data set directly or through a View button on the user interface.

In certain embodiments, a base word list associated with the selected data set is loaded into the floating memory. The software may be populated with associated information for the selected data set. Pictures or other imagery associated with the selected data set may be part of the associated information, and such pictures and imagery may be displayed on the user interface. Toggle View buttons may be presented through the user interface so that the user can turn off or on English (assumed to be the native tongue of the user in this example only), at least one predetermined foreign language, and Literal English displays. These displays may only persist until the next data set(s) in the lesson are selected, for example by using a backward and/or forward button. Alternatively, a Hide Detail button may be provided for the user to determine the persistence of data sets and their associated information.

In certain embodiments, there may be a check to determine if each selected data set and any constituent subsets have been previously retrievably stored in the floating dictionary.

The software audibly outputs the selected data set(s), relevant subsets and/or associated information. The software stores in the floating dictionary database such selected data set(s), relevant subsets and/or associated information if not previously retrievably stored. The software may retrieve the audio output from the floating dictionary database and stores it as a local file. The software may display a plurality of Listen buttons. These buttons may provide the ‘Listen to sentence form/subset/data set,’ with an arrow pointing at the relevant set.

In certain embodiments, the software may be adapted to determine if data sets or subsets thereof have been selected. If a data set is not selected, the entire data set may be electronically represented as a default, word by word. If only a subset is selected, then only the selected subset may be electronically represented.

In certain embodiments, Sets StartWord index=0. Sets EndWord index=base word list count minus 1 since Chinese words can be one or more characters. This code checks to see that the first and last characters of the selection are complete words, wherein sets StartWord index=relative index of the first selected word in the base word list, and wherein sets EndWord index=relative index of the last selected word in the Floating dictionary. The software may be adapted so that the StartWord and EndWord indices to play the appropriate subset in the base word list. The software may also be adapted to determine to see if the selected data set is in the floating dictionary and/or on the local machine.

The present invention may be a portion of a much larger textbook publishing and learning system.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method for learning a new language, comprising:
(a) electronically representing a plurality of data sets of the new language;
(b) providing a drill down functionality configured to prompt a user to select at least one first data set of the plurality of data sets;
(c) providing an audible representation associated with said at least one first data set;
(d) prompting the user to repeat said audible representation, select at least one second data set from the plurality of data sets, and select a first subset of said at least one first data set; and
(e) sequentially repeating steps (c) through (d) in respect of said at least one second and/or further data sets of the plurality of data sets or said second and/or further subsets of said at least one first data set.

2. The method of claim 1, further comprising importing the plurality of data sets from an external storage system.

3. The method of claim 1, wherein the plurality of data sets comprise at least one of a sentence form, a base subset or a structural subset of the new language.

4. The method of claim 1, further comprising providing a floating dictionary database configured to retrievably store the selected data sets and subsets from steps (c) and (d).

5. The method of claim 1, further comprising providing a literal English functionality configured to provide a literal translation of the selected data sets and subsets from steps (c) and (d) into an order that mimics the grammatical structure of the new language, wherein each literal translation is electronically represented adjacent to the selected data sets and subsets from steps (c) and (d).

6. The method of claim 1, further comprising providing a pictorial representation of imagery associated with the selected data sets and subsets from steps (c) and (d).

7. A computer implemented method for learning a new language, comprising:
(a) importing the plurality of data sets from an external storage system;
(b) electronically representing a plurality of data sets of the new language, wherein the plurality of data sets comprise at least one of a sentence form, a base subset or a structural subset of the new language;
(c) providing a drill down functionality configured to prompt a user to select at least one first data set of the plurality of data sets;
(d) providing an audible representation associated with said at least one first data set;
(e) prompting the user to repeat said audible representation, select at least one second data set from the plurality of data sets, and select a first subset of said at least one first data set;
(f) sequentially repeating steps (d) through (e) in respect of said at least one second and/or further data sets of the plurality of data sets or said second and/or further subsets of said at least one first data set;
(g) providing a floating dictionary database configured to retrievably store the selected data sets and subsets from steps (d) and (e);
(h) providing a literal English functionality configured to provide a literal translation of the selected data sets and subsets from steps (d) and (e) into an order that mimics the grammatical structure of the new language, wherein each literal translation is electronically represented adjacent to the selected data sets and subsets from steps (d) and (e); and
(i) providing a pictorial representation of imagery associated with the selected data sets and subsets from steps (d) and (e).
